(19) United States
(12) Patent Application Publication
(10) Pub. No.: US 2004/0136526 A1
(43) Pub. Date: Jul. 15, 2004

(54) Method for the creation of random values by a module associated with a microprocessor

(76) Inventors: Christophe Gien, Saint-Jean Le Blanc (FR); Jose Mennecart, Dry (FR)

Correspondence Address: SchlumbergerSema Inc, Intellectual Property Department, Suite 100, 3000 Mill Creek Avenue, Alpharetta, GA, 30022, US

(21) Appl. No.: 10/468,034

(22) PCT Filed: Feb. 20, 2002
(86) PCT No.: PCT/IB02/00509

(30) Foreign Application Priority Data
Feb. 22, 2001 (FR) 01/02385

(51) Int. Cl. H04K 1/00

(52) U.S. Cl. 380/28

(57) ABSTRACT

Method for the creation of at least one random value by a module (4) associated with a microprocessor (2) designed to execute successively at least one processing operation and one protection operation, the protection operation using the random value, the method including the following steps:

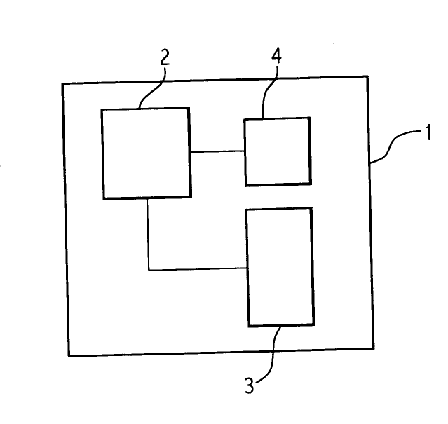

create the random value during the processing operation,

store the random value in a memory (3),

extract the random value from the memory to execute the protection operation.

This invention concerns a method for the creation of random values by a module associated with a microprocessor. The random values created are for example intended for the implementation of cryptographic methods used for example for secured data exchange, authentication operations, encryption operations, etc.

Such methods for the creation of random values are implemented in particular in integrated circuit cards including a microcontroller which includes a microprocessor associated with a memory and a random value creation module. When the card is inserted in a read terminal, the microprocessor executes processing operations for example to carry out the management of the microcontroller and its connection to the read terminal as well as data protection operations for example to authenticate an identification code of a user operating the read terminal. The protection operations implement an algorithm using a predetermined number of random values so that when execution of the protection operations starts, the microprocessor activates the random value creation module and waits. The random value creation module creates the random values and stores them in the memory. When the predetermined number of random values has been stored, the microprocessor continues executing the algorithm and extracts the random values from the memory. However, the time required to create each random value is relatively long. The microprocessor is therefore obliged to wait for a long time, which increases with the predetermined number of random values required for execution of the protection operations.

One purpose of the invention is to provide a means to limit the waiting time of the microprocessor when creating the random values.

The method used to achieve this purpose, according to the invention, includes the creation of at least one random value by a module associated with a microprocessor designed to execute successively at least one processing operation and one protection operation, the protection operation using the random value, the method including the following steps:

create the random value during the processing operation,

store the random value in a memory,

extract the random value from the memory to execute the protection operation.

Consequently, the random value is created whilst the microprocessor continues executing the processing operation and is available in the memory when the microprocessor starts the protection operation. The random value is therefore created whilst the processing operation is being executed by the microprocessor which therefore does not have to wait when the protection operations start.

Preferably, the microprocessor activates a possibility for interruption by the module so that the creation of a random value triggers an interruption in the execution of the processing operation in progress, the microprocessor executing during the interruption the following steps:

store the random value in the memory, and advantageously,

if the memory contains a number of random values less than a predetermined number, retain the possibility of interrupting and resuming the execution of the processing operation, the module being activated to create a new random value during the execution of the processing operation,

and if the memory contains a number of random values equal to the predetermined number, deactivate the possibility of interrupting the microprocessor by the module and resume execution of the processing operation.

The creation of each random value thereby generates an interruption in the execution of the processing operation by the microprocessor which then stores this random value.

Again preferably, the microprocessor activates the possibility of interruption and the module is activated to create a random value as soon as the microprocessor and the module are powered up.

A maximum amount of time is therefore available to create the random values before the start of the protection operation.

Advantageously, random values already having been stored, the method includes, before the storage step, a step which consists of comparing the random value to be stored with at least one of the random values already stored and, when the random value to be stored is identical to at least one of the random values already stored, the step of discarding or keeping the random value to be stored in relation with a pre-established rule.

It is therefore possible to ensure that the random values contained in the memory and which are to be used in the protection operation respect a rule, for example statistical according to a probability of reproducing the random value. This can also be used to check that the creation module is operating correctly.

Again advantageously, the random value to be stored is kept when it is not identical to the last random value stored in the memory.

We can therefore be certain that two random values used consecutively when executing the protection operation are different from each other.

Other features and advantages of the invention will appear on reading the description which follows of a special, non-limiting mode of realisation of the invention.

Reference will be made to a single FIGURE in appendix representing diagrammatically a microcontroller which can implement the method according to the invention.

In reference to the FIGURE, the method according to the invention is intended to be implemented using a microcontroller generally designated in 1 which includes a microprocessor 2 associated with a memory 3 of type random access memory (RAM) and an electronic module 4 for the creation of random values. The microprocessor 2, the memory 3 and the electronic module 4 are known types.

The microprocessor 2 is designed to execute a program which implements system processing operations to manage the microcontroller 1 and protection operations implementing for example an algorithm to authenticate an identification code. The authentication algorithm uses a predetermined number n of random values.

In the application described here, the microcontroller 1 is located in a card body not shown to form an integrated circuit card such as a bank card, an identification card or other.

In order to be used, the card is inserted in a read terminal which, in a known manner, supplies power to the microcontroller 1 and exchanges data with the microcontroller 1.

As soon as the microcontroller 1 is powered up, the microprocessor 2 starts to execute processing operations and activates a possibility for interruption by the electronic module 4 in the execution of the processing operations carried out by the microprocessor 2.As soon as the microcontroller 1 is powered up, the electronic module 4 is activated to automatically create random values.

The microprocessor 2 then executes the traditional processing operations such as sending the “card connected” response (ATR) to the read terminal.

Simultaneously, the electronic module 4 performs the operations required to create a random value.

Completion of the operations required to create the random value generates an interruption in the execution of the processing operation in progress. During this interruption, the microprocessor 2 executes a routine to store the random value created.

The microprocessor 2 starts by comparing the random value to be stored with at least one of the random values already contained in the memory 3 in order to, when the random value to be stored is identical with at least one of the random values already stored, discard or keep the random value to be stored according to a pre-established rule. In this case, the random value to be stored is kept when it is not identical to the last random value stored in the memory and discarded otherwise. Other rules may of course be used, especially statistical rules implementing a probability of reproducing random values or a rule specifying that the random value to be stored is in fact only stored if it is not already contained in the memory 3.

The memory 3 being empty, the microprocessor 2 stores the random value in the memory 3.

The microprocessor then activates again the electronic module 4 so that it creates a new random value and resumes execution of the processing operations.

These steps are repeated as long as the number of random values stored in the memory 3 is less than the number n.

Consequently, when a new random value is created, completion of the random value creation operations generates an interruption in the execution of the processing operations.

Then, as previously, the microprocessor 2 first checks by comparison that the random value to be stored is not identical to the last random value stored.

If the random value created is identical to the last random value stored in the memory 3, the microprocessor 2 does not store this random value but retains the possibility of interruption and resumes execution of the processing operations. Execution will then be interrupted again as soon as a new random value has been created by the electronic module 4 which is activated to automatically create random values.

If the random value created is not identical to the last random value stored in the memory 3, the microprocessor 2 stores the random value in the memory 3.

Each time a random value is stored, the microprocessor 2 increments a number corresponding to the number of random values stored. This therefore represents a simple means of counting the number of random values stored. Counting can also be carried out by decrementing a number corresponding to the number of random values still to be stored.

If the memory 3 contains a number of random values less than the number n, the activation of the possibility of interruption is maintained so that the electronic module 4 creates a new random value.

The microprocessor 2 then resumes execution of the processing operations until the next interruption.

When the memory 3 contains a number of random values equal to the predetermined number n, the microprocessor deactivates the possibility of interruption.

The microprocessor 2 then resumes execution of the processing operations.

The random value creation module continues to create random values. Creation of random values then no longer generates an interruption in the operation of the microprocessor 2 and the random values created are either not used or used in another electronic module for example to electrically disturb the power supply of the microprocessor.

When authentication is requested, the microprocessor 2 starts to execute the protection operations. It then executes the authentication algorithm and extracts from the memory 3 the random values which have been stored there.

At the end of the transaction with the read terminal, the card is withdrawn from the read terminal. The memory 3 is then erased.

Another advantage of the interruptions of the processing operation is to desynchronise the processing times, making external analysis of the microprocessor operation by unauthorised persons more difficult.

The invention is of course not limited to the method described and variants can be made without leaving the scope of the invention as defined by the claims.

In particular, although the method according to the invention has been described in relation with an integrated circuit card, the invention is not limited to this application and can be used in any computer system for example to perform authentication, encryption, signature operations, etc.

In addition, the electronic module 4 can be activated at any time during the execution of the processing operations by the microprocessor, preferably so that most or all of the random values required for the protection operations are available in memory when execution of the protection operations starts. Moreover, it is possible to plan that random values are created and stored in the memory as random values are extracted from it.

Although the storage step is carried out by the microprocessor in the mode of operation by interruption, storage can be carried out by the electronic module.

1. Method for the creation of at least one random value by a module (4) associated with a microprocessor (2) designed to execute successively at least one processing operation and one protection operation, the protection operation using a random value, characterised in that it includes the following steps:
create the random value during the processing operation,
after creating the random value, generate an interruption in the execution of the processing operation to store the random value in a memory (3),
extract the random value from the memory during the protection operation.

2. Method according to claim 1, characterised in that, before creating the random value, the microprocessor (2) activates a possibility of interruption by the module (4) so that the creation of the random value triggers an interruption in the execution of the processing operation in progress, the microprocessor executing during the interruption the step of storing the random value in the memory (3).

3. Method according to claim 2, characterised in that, after storing the random value, the microprocessor (2) executes the following steps:
if the memory contains a number of random values less than a predetermined number, maintain the possibility of interrupting and resuming execution of the processing operation, the module (4) being activated to create a new random value during the execution of the processing operation,
and if the memory contains a number of random values equal to the predetermined number, deactivate the possibility of interrupting the microprocessor by the module and resume execution of the processing operation.

4. Method according to claim 2 or claim 3, characterised in that the microprocessor (2) activates the possibility of interruption and the module (4) is activated to create a random value, as soon as the microprocessor and the module are powered up.

5. Method according to any one of claims 1 to 4, characterised in that, random values already having been stored, the method includes, before the storage step, a step which consists of comparing the random value to be stored with at least one of the random values already stored and, when the random value to be stored is identical to at least one of the random values already stored, the step of discarding or keeping the random value to be stored in relation with a pre-established rule.

6. Method according to claim 5, characterised in that, according to the pre-established rule, the random value to be stored is kept when it is not identical to the last random value stored in the memory.
